(19) United States
(12) Patent Application Publication
(10) Pub. No.: US 2026/0257619 A1
(43) Pub. Date: Sep. 3, 2026

(54) MOTOR VEHICLE WITH ELECTRONICALLY CONTROLLED INTERIOR LIGHTING SYSTEM THAT IS RECONFIGURABLE FROM A REMOTE SERVER, AND RELATED CONTROL METHOD

(71) Applicant: Stellantis Europe S.p.A., Torino (IT)

(72) Inventor: Vincenzo MASCIAVÈ, Torino (IT)

(73) Assignee: Stellantis Europe S.p.A., Torino (IT)

(21) Appl. No.: 19/164,911

(22) PCT Filed: Mar. 1, 2024
(86) PCT No.: PCT/IB2024/051996

§ 371 Date: Sep. 12, 2025

(30) Foreign Application Priority Data
Mar. 14, 2023 (IT) 102023000004782

(51) Int. Cl. B60Q 3/80; B60Q 3/16; B60Q 3/217; B60Q 3/233; B60Q 3/70; H05B 47/105

(52) U.S. Cl. CPC B60Q 3/80; B60Q 3/16; B60Q 3/217; B60Q 3/233; B60Q 3/70; H05B 47/105; B60Q 2500/30; B60Q 2900/30

(57) ABSTRACT

A motor vehicle has an interior lighting system including light sources arranged on visible surfaces of a passenger compartment thereof, and an electronic controller, which is configured for controlling switching-on of the light sources according to a pre-set time sequence to obtain a variation in time of the shape and/or position of illuminated portions of the surfaces to give rise to an animation effect. At least some of the light sources are controlled and configured to generate a light having any color. The electronic controller varies the animation effect as a function of a speed of the vehicle, a longitudinal acceleration and deceleration of the vehicle, a distance of the vehicle from a vehicle that precedes it along the road, and activation of the brakes.

### FIELD OF THE INVENTION

The present invention relates to motor vehicles of the type comprising an interior lighting system that includes:
a plurality of light sources arranged on visible surfaces of the passenger compartment of the motor vehicle, said surfaces being chosen from among the surface of the dashboard of the motor vehicle, the surface of interior panels of the doors of the motor vehicle, the surface of one or more armrests of the motor vehicle, the surface of the interior coating panel of the roof of the motor vehicle, the surface of a central console of the passenger compartment of the motor vehicle, and the surface of an instrument panel of the motor vehicle; and
an electronic controller, configured for controlling, according to a pre-set control program, switching-on of said light sources arranged on said visible surfaces of the passenger compartment of the motor vehicle,
at least some of said light sources being light sources configured and controlled by said electronic controller in such a way as to generate a light having a given colour.

### PRIOR ART

A motor vehicle of the type referred to above is, for example, described in WO 2022/223309A1.

In recent times there has been an ever-increasing spread in the use of interior lighting systems for motor vehicles of the type referred to above, aimed at generating in the user, in the various operating conditions of the motor vehicle, the impression of an environment that is comfortable and welcoming and/or at the same time is provided with a series of optical functions that facilitate driving and/or activation of commands and/or that improve safety conditions.

A motor vehicle of the type referred to in the preamble of claim 1 is known from the document US 2021/261050A1. Other solutions are known from the documents DE 10 2017 213994A1, DE 10 2011 013 777A1, DE 10 2012 025619A1, DE 10 2016 001204 A1 and FR 3 056 537A1.

### OBJECT OF THE INVENTION

The object of the present invention stems from the desire to provide an electronically controlled interior lighting system for motor vehicles of the type described above, the characteristics and functions of which may be modified, with simple and fast operations, in an extremely flexible way, by the user himself or herself so as to renew the way the motor vehicle was originally fitted out.

A further object of the invention is to provide an interior lighting system designed to create, when activated, an optical effect of animation linked to at least one operating parameter of the motor vehicle, such as the speed of the motor vehicle, so as to allow the user to have an immediate visual perception of the aforesaid parameter, at the same time enabling the user to modify, with simple and fast operations, in an extremely flexible way, both the above animation effect and the operating parameter of the motor vehicle to which said animation effect is linked.

### SUMMARY OF THE INVENTION

With a view to achieving one or more of the aforesaid objects, the subject of the invention is a motor vehicle having the characteristics indicated in the annexed claim 1.

OTA (Over-The-Air) technology is in itself known. It envisages a type of data exchange that enables updating of the software of an electronic device via a point-to-point communication and by means of a wireless network (e.g., of the 5G type).

The aforesaid at least one operating parameter of the motor vehicle includes the speed of the motor vehicle and the longitudinal acceleration and deceleration of the motor vehicle, a parameter indicating the distance of the vehicle from a vehicle that precedes it along the road, and a parameter indicating activation of the brakes.

The joint adoption, as operating parameters that affect the lighting-animation effect inside the passenger compartment of the motor vehicle, of the speed of the motor vehicle, of the longitudinal acceleration and deceleration of the motor vehicle, of the distance of the vehicle from a vehicle that precedes it along the road, and of activation of the brakes, enables new and original light effects to be obtained, to the advantage also of safety for the occupants of the motor vehicle.

Thanks to the aforesaid characteristics, the system proposed in the present disclosure affords a plurality of advantages. In the first place, the manufacturer of the motor vehicle can make periodically available and selectable by the user a plurality of new features for the interior lighting system. Moreover, each given feature may envisage a given animation effect and a given operating parameter of the motor vehicle to which the animation effect is linked.

It is also possible to envisage that the user will receive a notification on a portable electronic device informing him or her for the motor vehicle in use that one or more new features for the interior lighting system have been made available, from which the user can select the modifications to make to the interior of the motor vehicle according to his or her own personal taste.

In a further embodiment, it is also possible to envisage, for example, that the animation effect is linked to a signal indicating a vital function of the driver that comes from a sensor associated to the driver's body, in order, for example, to attract the attention of the driver in the event where the function of monitoring the vital parameters detects a tendency of the driver to fall asleep.

A subject of the invention is also a control method that can be implemented by means of the system described above.

Further characteristics and advantages of the invention will emerge from the ensuing description with reference to the annexed drawings, which are provided purely by way of non-limiting example and in which:

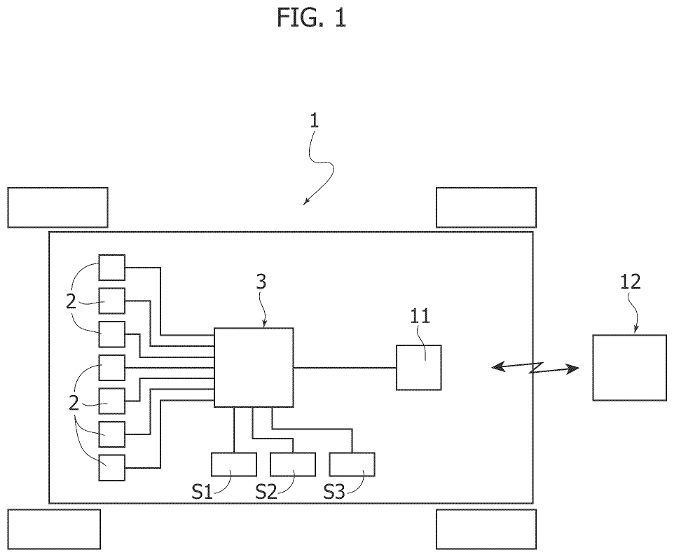

FIG. 1 is a schematic view of a motor vehicle according to the present invention;

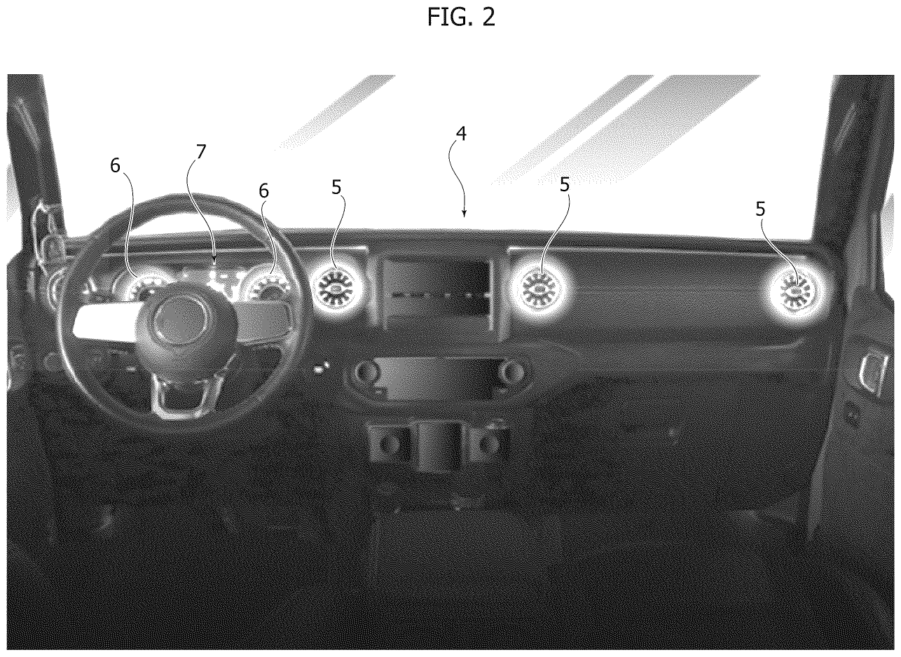

FIG. 2 is a view exemplifying a motor-vehicle dashboard provided with an interior lighting system according to the present invention;

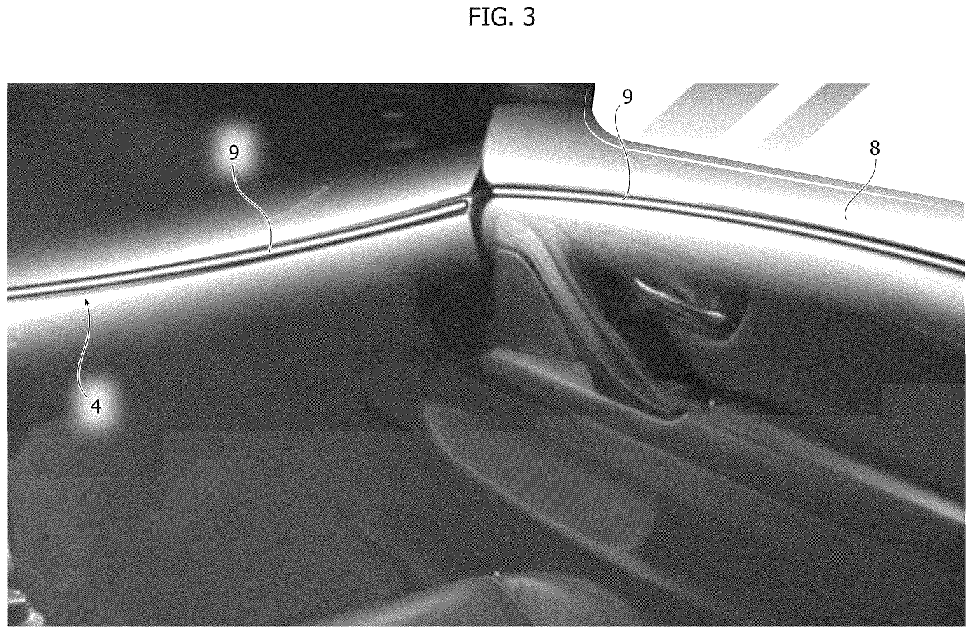

FIG. 3 is a further view of a detail of a passenger compartment of a motor vehicle provided with an interior lighting system according to the invention; and

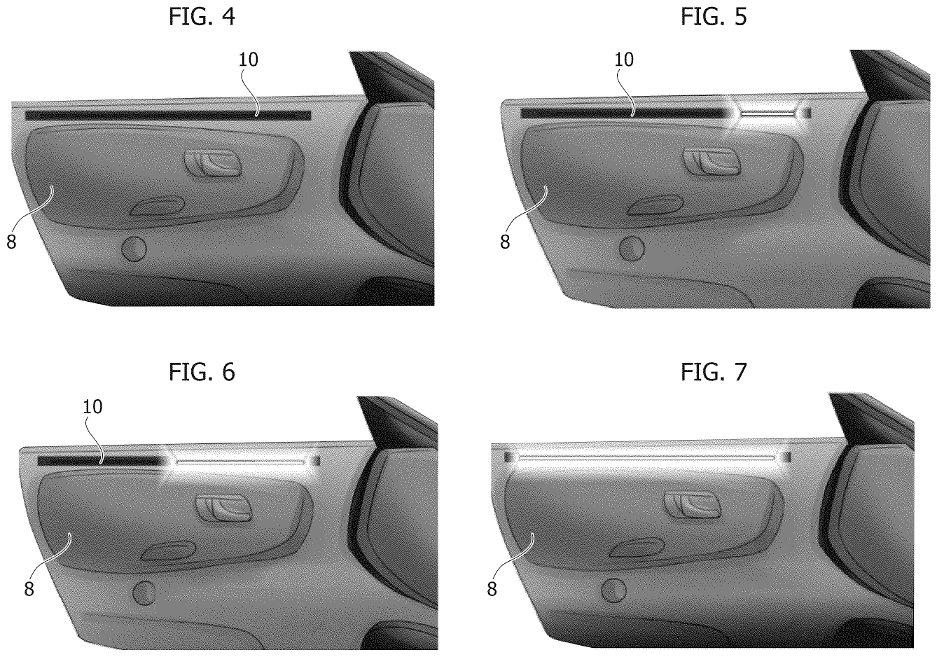

FIGS. 4-7 are views that illustrate different steps of an animation effect that can be provided by means of the system according to the invention.

With reference to FIG. 1, the reference number 1 designates as a whole a motor vehicle provided with an interior lighting system that comprises a plurality of light sources 2 arranged on visible surfaces of the passenger compartment of the motor vehicle, for example on the surface of the dashboard of the motor vehicle and/or on the interior panels of the doors of the motor vehicle, and/or on the surface of one or more armrests of the motor vehicle and/or on the surface of the interior coating panel of the roof of the motor vehicle and/or on the surface of a central console of the passenger compartment of the motor vehicle and/or on the surface of an instrument panel.

Provided on board the motor vehicle is an electronic controller 3 configured for controlling switching-on of the light sources 2 that are arranged on the visible surfaces of the passenger compartment of the motor vehicle, according to a pre-set time sequence in such a way as to obtain a variation in time of the shape and/or position of illuminated portions of the aforesaid surfaces so as to give rise to an animation effect.

According to a further characteristic, at least some of the aforesaid light sources 2 are light sources (e.g., LED sources based upon RGB technology) configured and controlled by the electronic controller 3 for generating a light having any pre-set colour that is a function of the RGB co-ordinates that are indicated to the electronic controller for each light source 2.

In the present description, the expression “electronic controller” is to be understood both as the case of a single electronic controller that performs operations that are described hereinafter and the case of a number of electronic controllers, each pre-arranged for carrying out given functions.

FIG. 2 of the annexed drawings represents by way of example a dashboard 4 in the passenger compartment of a motor vehicle that has, for example, illuminated portions 5 surrounding aeration louvres provided on the dashboard and illuminated portions 6 surrounding the instruments of the motor-vehicle instrument panel 7.

FIG. 3 shows purely by way of example a detail of a motor-vehicle passenger compartment, where along the dashboard 4 and along the interior panel 8 of each front door of the motor vehicle there may be lit up a luminous strip 9 that has, for example, a given colour or else a colour that varies progressively in time, or else that can light up progressively throughout its length.

FIGS. 4-7 show by way of example an animated light effect obtained along a longitudinal strip 10, provided on the interior panel 8 of each front door, wherein the strip 10 lights up progressively from its front end (to the right in the figures) to its rear end, in a cyclic way, with a speed and a frequency that are, for example, linked to the speed of the motor vehicle.

For this purpose, with reference once again to FIG. 1, the system according to the invention may envisage a plurality of sensors S1, S2, S3, which detect operating parameters of the motor vehicle (e.g., the speed of the motor vehicle, or else the longitudinal acceleration or deceleration of the motor vehicle, or else activation of the brakes, or else the distance of the motor vehicle from a vehicle that precedes it, or else, for example, also a deviation of the motor vehicle with respect to a lane travelled along by the motor vehicle) so as to give rise to light effects that are also of assistance to driving.

The electronic controller 3 is configured and programmed to obtain a given visual effect, and/or a given animation effect and/or, a given colour of the light emitted by the light sources 2, which for this purpose are provided at least in part as light sources configured and controlled for generating a light having any pre-set colour (e.g., LED sources based upon RGB technology). The electronic controller 3 can hence be configured with the chromatic co-ordinates that identify the colour that is to be emitted by each light source 2.

According to an important characteristic of the invention, associated to the electronic controller 3 (see FIG. 1) is a communication unit 11, configured for a communication via OTA (Over-The-Air) technology with a remote server 12, which is configured for downloading, upon command, to the electronic controller 3 an updating program that modifies the program that determines the animation effect generated by the light sources 2 and/or even just the colour of the light emitted by the light sources 2. For this purpose, the updating program may, for example, include the chromatic co-ordinates of the light that is to be emitted by each light source 2. Moreover, the program resident in the electronic controller 3 may be updated also with reference to the variation of the animation effects, obtained via the light sources 2, according to one or more operating parameters of the motor vehicle.

Thanks to the arrangement described above, the manufacturer of the motor vehicle can enable the user to modify and update the visual effects produced by the interior lighting system, by changing, for example, the colour of the light emitted by the light sources, and/or the animation effects, and/or the variation of the animation effects as the operating parameters of the motor vehicle vary. In other words, the manufacturer of the motor vehicle enables the user to renew the features of the interior lighting system with respect to those originally provided.

It may be envisaged, for example, that the user will receive on a portable electronic device a notification informing him or her of the possibility of selecting from among one or more new features of the interior lighting system provided by the manufacturer of the motor vehicle. Once the choice has been made, the operation of updating the program resident on the on-board electronic controller can be carried out in a simple and fast way, via OTA technology.

The user is thus able to change the general aesthetic effect produced by the interior lighting system and/or modify and/or add new lighting functions, for example introducing new optical effects of assistance to driving.

As mentioned above, in a further embodiment it is also possible to envisage, for example, that the animation effect will be linked to a signal indicating a vital function of the driver, coming from a sensor associated to the driver's body (e.g., a smartwatch or a heart-rate monitor, or a sensor of the driver's breathing) in order, for example, to attract the attention of the driver in the event where the function of monitoring the vital parameters detects a tendency of the driver to fall asleep.

Of course, without prejudice to the principle of the invention, the details of construction and the embodiments may vary widely with respect to what has been described and illustrated herein purely by way of example, without thereby departing from the scope of the present invention.

1. A motor vehicle, comprising an interior lighting system including:
a plurality of light sources arranged on visible surfaces of the passenger compartment of the motor vehicle, said surfaces being chosen from among surface of the dashboard of the motor vehicle, a surface of interior panels of doors of the motor vehicle, a surface of one or more armrests of the motor vehicle, a surface of the interior coating panel of a roof of the motor vehicle, a surface of a central console of the passenger compartment of the motor vehicle, and a surface of an instrument panel of the motor vehicle; and
an electronic controller, configured for controlling, according to a pre-set control program, switching-on of said light sources arranged on said visible surfaces of the passenger compartment of the motor vehicle,
at least some of said light sources being light sources configured and controlled by said electronic controller in such a way as to generate a light having any pre-set color,
and wherein:
the electronic controller is configured for controlling switching-on of at least some of said light sources arranged on said visible surfaces of the passenger compartment of the motor vehicle according to a pre-set time sequence to obtain a variation in time of a shape and/or a position of illuminated portions of said surfaces so as to give rise to an animation effect;
the electronic controller is configured for controlling at least some of said light sources in such a way as to change the aforesaid animation effect as a function of a signal indicating at least one operating parameter of the motor vehicle, which is sent to said electronic controller by at least one sensor of the motor vehicle;
associated to the electronic controller is a communication unit configured for a communication via OTA (Over-The-Air) technology with a remote server configured for downloading to the electronic controller an updating program that modifies the program for control of the electronic controller in such a way as to change color of the light emitted by said light sources and/or the shape and position of the illuminated surface portions and/or the animation effect, and/or said at least one operating parameter of the motor vehicle to which the animation effect is linked; and
said at least one operating parameter of the motor vehicle includes a speed of the motor vehicle, and wherein said at least one operating parameter of the motor vehicle further includes:
a longitudinal acceleration and deceleration of the motor vehicle;
a parameter indicating the distance of the vehicle from a second vehicle that precedes the vehicle along the road; and
a parameter indicating activation of the brakes.

2. The motor vehicle according to claim 1, wherein said electronic controller is configured for controlling at least some of said light sources according to a pre-set program in such a way as to change the animation effect and/or the color of the light generated by said light sources according to a signal indicating a vital function of the driver that comes from a sensor associated to the driver's body.

3. A method for controlling an interior lighting system of a motor vehicle, wherein said system includes:
a plurality of light sources arranged on visible surfaces of a passenger compartment of the motor vehicle, said surfaces being chosen from among a surface of the dashboard of the motor vehicle, a surface of interior panels of the doors of the motor vehicle, a surface of one or more armrests of the motor vehicle, a surface of an interior coating panel of a roof of the motor vehicle, a surface of a central console of the passenger compartment of the motor vehicle, and a surface of an instrument panel of the motor vehicle,
said method comprising controlling, via an electronic controller, according to a pre-set control program, switching-on of said light sources arranged on said visible surfaces of the passenger compartment of the motor vehicle,
wherein at least some of said light sources are light sources that are configured and controlled by the electronic controller in such a way as to generate a light having any pre-set color,
wherein said method further comprises:
controlling switching-on of at least some of said light sources arranged on said visible surfaces of the passenger compartment of the motor vehicle according to a pre-set time sequence to obtain a variation in time of a shape and/or a position of illuminated portions of said surfaces so as to give rise to an animation effect; and
controlling, via said electronic controller, at least some of said light sources in such a way as to change the animation effect according to a signal indicating at least one operating parameter of the motor vehicle, which is sent to said electronic controller by at least one sensor of the motor vehicle,
and wherein associated to the electronic controller is a communication unit configured for a communication via OTA (Over-The-Air) technology with a remote server, the method including downloading to the electronic controller, from said remote server, via said communication unit, an updating program that modifies the program for control of the electronic controller in such a way as to change the color of the light emitted by said light sources and/or the shape and position of the illuminated surface portions and/or the animation effect, and/or said at least one operating parameter of the motor vehicle to which the animation effect is linked,
wherein said at least one operating parameter of the motor vehicle includes a speed of the motor vehicle, and wherein said at least one operating parameter of the motor vehicle further includes:
a longitudinal acceleration and deceleration of the motor vehicle;
a parameter indicating the distance of the vehicle from a second vehicle that precedes the vehicle along the road; and
a parameter indicating activation of the brakes.

4. The method according to claim 3, comprising controlling, via said electronic controller, at least some of said light sources according to a pre-set program in such a way as to change the animation effect and/or the color of the light generated by said light sources as a function of a signal indicating a vital function of the driver that comes from a sensor associated to the driver's body.
